(19) United States
(12) Patent Application Publication
(10) Pub. No.: US 2024/0116820 A1
(43) Pub. Date: Apr. 11, 2024

(54) SINTERED BODY

(71) Applicant: Murata Manufacturing Co., Ltd., Nagaokakyo-shi (JP)

(72) Inventor: Eigo KOBAYASHI, Nagaokakyo-shi (JP)

(21) Appl. No.: 18/535,025

(22) Filed: Dec. 11, 2023

Related U.S. Application Data
(63) Continuation of application No. PCT/JP22/39159, filed on Oct. 20, 2022.

(30) Foreign Application Priority Data
Oct. 28, 2021 (JP) 2021-176701

(51) Int. Cl. C04B 35/26; H01F 1/34

(52) U.S. Cl. CPC C04B 35/265; H01F 1/344; C04B 2235/3217; C04B 2235/3241; C04B 2235/3244; C04B 2235/3265; C04B 2235/3274; C04B 2235/3277; C04B 2235/3279; C04B 2235/3281; C04B 2235/3284; C04B 2235/763

(57) ABSTRACT

A sintered body that includes: a spinel ferrite oxide having a main constituent of metal elements of Fe, Ni, Cu, and Zn; and Zr, Mn, Al, Co, and Cr. Wherein, when Zn, Ni, Cu, Zr, Mn, Al, Co, and Cr have a contained mole part: “a”, “b”, “c”, “d”, “e”, “f”, “g”, and “h”, respectively, and based on Fe being 100 mole parts: 49.0<100−a−b−c+2d+(1/2)e<50.0, 50.2<a+b+c+d+e/2<52.7, 0.0012≤f≤0.010, 0.0005≤g≤0.0015, and 0.0005≤h≤0.004.

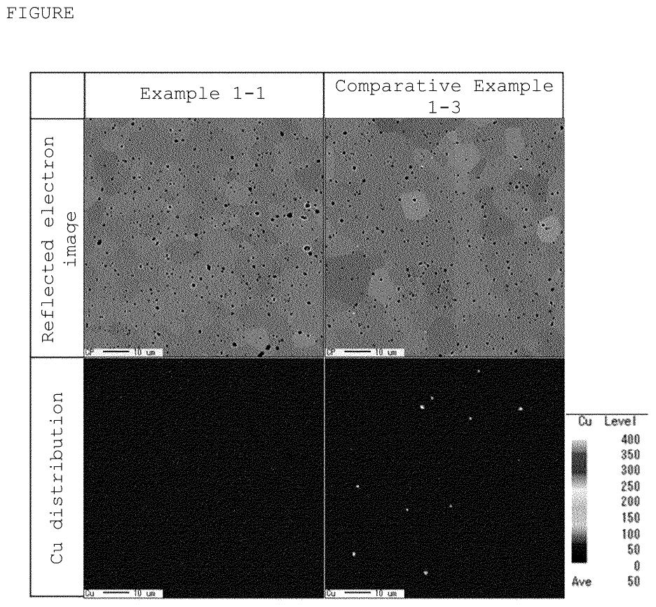

### CROSS REFERENCE TO RELATED APPLICATIONS

The present application is a continuation of International application No. PCT/JP2022/039159, filed Oct. 20, 2022, which claims priority to Japanese Patent Application No. 2021-176701, filed Oct. 28, 2021, the entire contents of each of which are incorporated herein by reference.

### TECHNICAL FIELD

The present disclosure relates to a sintered body, more specifically, a sintered body containing a spinel ferrite oxide.

### BACKGROUND ART

There has been a demand for downsizing and densification of electronic equipment, and in recent years, frequency for use is becoming higher. In particular, as a magnetic material of a transformer for a power supply used in a high-frequency region, Mn—Zn-based ferrite, which is easily magnetized with respect to a slight magnetic field and has a small power loss, Ni—Zn-based ferrite, which has a high specific resistance, and the like are used. Japanese Patent Application Laid-Open No. 2012-96961 (hereinafter “Patent Document 1”) discloses a Ni—Zn-based ferrite composition having a reduced power loss in a high frequency region and having a high initial magnetic permeability and a high specific resistance. The Ni—Zn-based ferrite composition contains, as the main constituent, 47.1 to 49.95 mol % of iron oxide in terms of Fe₂O₃, 2.3 to 10.0 mol % of copper oxide in terms of CuO, 27.6 to 32.0 mol % of zinc oxide in terms of ZnO, and 0.01 to 2.1 mol % of manganese oxide in terms of Mn₂O₃, has the balance made of nickel oxide, and contains, as accessory components, 2 to 63 ppm of phosphorus in terms of P, 43 to 4530 ppm of zirconium oxide in terms of ZrO₂, and 0.01 to 0.15 parts by weight of molybdenum oxide in terms of MoO₃, with respect to 100 parts by weight of the main constituent.

### SUMMARY OF THE INVENTION

In recent years, a magnetic material having a high Curie point (Tc) and exhibiting higher magnetic permeability in a high frequency range of, for example, 100 kHz or more has been further required. However, in the Ni—Zn-based ferrite composition of Patent Document 1, it is difficult to achieve the properties, and it is considered that further improvement is necessary. The present disclosure has been made in view of the above circumstances, and an object thereof is to provide a sintered body having a high Curie point and exhibiting high magnetic permeability in a high frequency range.

According to one gist of the present invention, provided is a sintered body including: a spinel ferrite oxide having a main constituent of metal elements of Fe, Ni, Cu, and Zn; and Zr, Mn, Al, Co, and Cr. Wherein, when Zn, Ni, Cu, Zr, Mn, Al, Co, and Cr have a contained mole part: “a”, “b”, “_{c}”, “d”, “e”, “f”, “g”, and “h”, respectively, and based on Fe being 100 mole parts:

49.0<100−a−b−c+2d+(1/2)e<50.0,

50.2<a+b+c+d+e/2<52.7,

0.0012≤f≤0.010,

0.0005≤g≤0.0015, and

0.0005≤h≤0.004.

In one embodiment of the present invention, in the sintered body, the “d” preferably satisfies the following formula (6), and the “e” preferably satisfies the following formula (7):

0.10≤d≤0.50 (6), and

0.055≤e≤0.25 (7).

According to the present disclosure, it is possible to provide a sintered body having a high Curie point and exhibiting high magnetic permeability in a high frequency region.

### BRIEF EXPLANATION OF THE DRAWING

The FIGURE is a micrograph showing a reflected electron image and Cu distribution of the section of a sintered body observed by SEM-WDX (Scanning Electron Microscope-Wavelength Dispersive X-ray spectroscopy).

### DETAILED DESCRIPTION OF PREFERRED EMBODIMENTS

The sintered body of the present embodiment includes: a spinel ferrite oxide whose main constituent of metal elements is Fe, Ni, Cu, and Zn; and Zr, Mn, Al, Co, and Cr. Wherein, based on Fe being 100 mole parts, when Zn, Ni, Cu, Zr, Mn, Al, Co, and Cr have a contained mole part: “a”, “b”, “c”, “d”, “e”, “f”, “g”, and “h”, respectively:

49.0<100−a−b−c+2d+(1/2)e<50.0 (1),

50.2<a+b+c+d+e/2<52.7 (2),

0.0012≤f≤0.010 (3),

0.0005≤g≤0.0015 (4), and

0.0005≤h≤0.004 (5).

In the spinel ferrite oxide contained in the sintered body of the present embodiment, the main constituent of metal elements contained is Fe, Ni, Cu, and Zn. In the present specification, the term “main constituent” refers to 50 mol % or more. The ratio of Fe, Ni, Cu and Zn to all the metal elements contained in the spinel ferrite oxide may be 50 mol % or more, further 60 mol % or more, and further 70 mol % or more.

The content of each metal element of the main constituent is not particularly limited. For example, as the content of each metal element, when Zn, Ni, and Cu have a contained mole part value: “a”, “b”, and “c”, respectively, based on Fe being 100 mole parts, all of “a”, “b”, and “c” are more than 0, and “a” may be in the range of 23.9 or more and 34.6 or less. “b” may be in the range of 6.7 or more and 27.0 or less. “c” may be in the range of 0.1 or more and 10.2 or less.

The sintered body of the present embodiment contains the spinel ferrite oxide. The ratio of the spinel ferrite oxide in the sintered body of the present embodiment is preferably 90 mass % or more, and more preferably 95 mass % or more. In the sintered body of the present embodiment, the ratio of the spinel ferrite oxide may be substantially 100 mass %, that is, the sintered body may be formed of the spinel ferrite oxide. The sintered body of the present embodiment may contain, for example, carbon, sulfur, and the like derived from a binder and the like used at the time of production as inevitable impurities within a range of, for example, 5 mass % or less in total, and further 1 mass % or less in total.

The sintered body of the present embodiment further contains Zr, Mn, Al, Co, and Cr. “a”, “b”, “c”, “d”, “e”, “f”, “g”, and “h”, each of which indicates the content of each of Fe, Ni, Cu, and Zn, and these elements in terms of contained mole part based on Fe being 100 mole parts, satisfy all of the above formulas (1) to (5). These formulas will be described below.

In the present embodiment, it has been found that when the total amount (mol %) of Fe₂O₃, Mn₂O₃, and (3/2) ZrO₂, that is, [Fe₂O₃+Mn₂O₃+(3/2) ZrO₂], in the sintered body is set within a predetermined range, and the content of each of Al, Co, and Cr is strictly controlled within the above range, the magnetic permeability (μ′) in a high frequency region is remarkably improved (Hereinafter, realizing high μ′ may be referred to as “higher μ′”.). First, realizing higher μ′ in a high frequency region by controlling [Fe₂O₃+Mn₂O₃+(3/2)ZrO₂] will be described.

[Realizing Higher μ′ in High Frequency Region by Controlling [Fe₂O₃+Mn₂O₃+(3/2) ZrO₂] ]

The spinel ferrite oxide is represented by AO·B2O3 (A: divalent ion, B: trivalent ion). When the amount of trivalent ions constituting the oxide is excessive, a part of Fe³⁺ becomes Fe²⁺ for charge compensation, and the magnetic permeability (μ′) in a high frequency region decreases. In addition, in the spinel ferrite oxide containing Fe—Ni—Cu—Zn as the main constituent, Mn can also be present as trivalent. Therefore, conventionally, as a means for increasing magnetic permeability, the amount of each of Fe and Mn, which are capable of forming a trivalent ion, has been suppressed to a predetermined amount or less. However, in the present invention, when the relationship between the composition of the spinel ferrite oxide containing Fe—Ni—Cu—Zn as the main constituent and charge compensation was carefully examined, it was found that Zr⁴⁺ also contributes thereto. Therefore, when [Fe₂O₃+Mn₂O₃+(3/2)ZrO₂] was set as an index including Zr, and this index was applied in designing the component composition, it was found that there was a correlation with μ′ in a high frequency region, and thus μ′ in a high frequency region was reliably increased.

In the present invention, the value of the contained mole part of each of Zn, Ni, Cu, Zr, and Mn based on Fe being 100 mole parts is represented by “a”, “b”, “c”, “d”, and “e”, respectively, and [Fe₂O₃+Mn₂O₃+(3/2) ZrO₂] is controlled by [100−a−b−c+2d+(1/2)e] (hereinafter, may be referred to as “α value”), which is represented by the contained mole part of each element. First, the method for converting [Fe₂O₃+Mn₂O₃+(3/2) ZrO₂] into [100−a−b−c+2d+(1/2)e], which is represented by the contained mole part of each element, will be described.

Each of Fe, Ni, Zn, Cu, Mn, and Zr contained in the spinel ferrite oxide of the present embodiment is converted into an oxide (Fe₂O₃, NiO, ZnO, CuO, Mn₂O₃, and ZrO₂). When the sum is set to 100 mole parts, the sintered body of the present embodiment, having the content of each of Fe₂O₃, Mn₂O₃, and ZrO₂ satisfying the following range, can reliably increase μ′ in a high frequency region. The reason for setting the range will be described in detail later.

49.50<[Fe₂O₃+Mn₂O₃+(3/2)ZrO₂]<50.00 (1a)

The above formula (1a) is divided into two: the following formula (1b) and the following formula (1c).

49.50<[Fe₂O₃+Mn₂O₃+(3/2)ZrO₂] (1b)

[Fe₂O₃+Mn₂O₃+(3/2)ZrO₂]<50.00 (1c)

When the contained mole part value of each of Zn, Ni, Cu, Zr, and Mn based on Fe being 100 mole parts is set to “a”, “b”, “c”, “d”, and “e”, the mol % of Fe₂O₃, ZrO₂, and Mn₂O₃ is represented by the following formulas (1d), (1e), and (1f) using “a”, “b”, “c”, “d”, and “e”, respectively.

Fe₂O₃={50/(50+a+b+c+d+e/2)}×100 (1d)

ZrO₂={d/(50+a+b+c+d+e/2)}×100 (1e)

Mn₂O₃={(e/2)/(50+a+b+c+d+e/2)}×100 (1f)

The formulas (1d), (1e), and (1f) are substituted into the formula (1b) to calculate the following formula (1g).

49.50<{(50+(3/2)d+e/2)/(50+a+b+c+d+e/2)}×100

50+a+b+c+d+e/2<(50+(3/2)d+e/2)×2.02

50+a+b+c+d+e/2<101+3.03d+1.01e

49.0<100−a−b−c+2.03d+0.51e (1g)

By considering 2.03≈2 and 0.51≈1/2 in the formula (1g), the formula (1h) is obtained.

49.0<100−a−b−c−2d+e/2 (1h)

The formulas (1d), (1e), and (1f) are substituted into the formula (1c) to calculate the following formula (1i).

{(50+(3/2)d+e/2)/(50+a+b+c+d+e/2)}×100<50.00

100+3d+e<50.0+a+b+c+d+e/2

100−a−b−c+2d+e/2<50.0 (1i)

By combining the formula (1h) and the formula (1i), the formula (1) is obtained. All of “a” “b” “c” “d” and “e” are more than 0.

49.0<100−a−b−c+2d+(1/2)e<50.0 (1)

When [100−a−b−c+2d+(1/2)e] representing the amount (mol %) of [Fe₂O₃+Mn₂O₃+(3/2) ZrO₂] is too small, oxygen defects increase in the spinel ferrite oxide. As a resolution thereof, CuO is easily discharged from the spinel crystal to the outside during firing, and as a result, CuO segregation increases, and μ′ in a high frequency region decreases. Therefore, by increasing the amount of [Fe₂O₃+Mn₂O₃+(3/2)ZrO₂], the amount of oxygen defects can be reduced, and μ′ in a high frequency region is improved. From these viewpoints, [100−a−b−c+2d+(1/2)e] is more than 49.0. [100−a−b−c+2d+(1/2)e] may be 49.5 or more.

Increased [100−a−b−c+2d+(1/2)e] makes it easy to realize higher μ′ in a high frequency region. On the other hand, when [100−a−b−c+2d+(1/2)e] is 50 or more, a part of Fe³⁺ becomes Fe²⁺ for charge compensation, hopping conduction between Fe³⁺ and Fe²⁺ occurs, and this becomes a source of causing a relaxation loss, so that μ′ in a high frequency region decreases. Therefore, [100−a−b−c+2d+(1/2)e] is less than 50.0. [100−a−b−c+2d+(1/2)e] may be 49.8 or less.

As shown in the prior art, when the total amount of Fe₂O₃ and Mn₂O₃ is about 50 mol % or less, it has been difficult to reliably increase μ′ in a high frequency region. According to the present invention, it has been found that when [Fe₂O₃+Mn₂O₃+(3/2) ZrO₂] satisfies particularly less than 50.00 mol %, that is, 100−a−b−c+2d+(1/2)e<50.0, decrease in μ′ in a high frequency region due to relaxation loss can be reliably suppressed.

It is also important to define the amount of Fe₂O₃ together with the α value in realizing higher μ′ in a high frequency region. Hereinafter, realizing higher in a high frequency region by controlling the amount of Fe₂O₃ will be described.

[Realizing Higher μ′ in High Frequency Region by Controlling the Amount of Fe₂O₃]

By also controlling the amount of Fe₂O₃ in the sintered body of the present embodiment, μ′ can be reliably improved in a high frequency region. In the present invention, the amount (mol %) of Fe₂O₃ is controlled through [a+b+c+d+e/2] (hereinafter, may be referred to as “β value”), which is represented by the contained mole part of each element in the same manner as in the α value. First, the method of converting the amount of Fe₂O₃ to [a+b+c+d+e/2], which is represented by the contained mole part of each element, will be described.

Each of Fe, Ni, Zn, Cu, Mn, and Zr contained in the spinel ferrite oxide of the present embodiment is converted into an oxide (Fe₂O₃, NiO, ZnO, CuO, Mn₂O₃, and ZrO₂). When the sum is set to 100 mole parts, the spinel ferrite oxide of the present embodiment, having the content of Fe₂O₃ satisfying the following range, can reliably increase μ′ in a high frequency region.

48.67<Fe₂O₃<49.91 (2a)

The above formula (2a) is divided into two: the following formula (2b) and the following formula (2c).

48.67<Fe₂O₃ (2b)

Fe₂O₃<49.91 (2c)

When the contained mole part value of each of Zn, Ni, Cu, Zr, and Mn based on Fe being 100 mole parts is set to “a”, “b”, “c”, “d”, and “e”, Fe₂O₃ is represented by the following formula (2d) using “a”, “b”, “c”, “d”, and “e”, respectively.

Fe₂O₃=50/(50+a+b+c+d+e/2)×100 (2d)

The formula (2d) is substituted into the formula (2b) to calculate the following formula (2e).

48.67<{50/(50+a+b+c+d+e/2)}×100

50+a+b+c+d+e/2<5000/48.67

a+b+c+d+e/2<52.7 (2e)

The formula (2d) is substituted into the formula to calculate the following formula (2f).

{50/(50+a+b+c+d+e/2)}×100<49.91

5000/49.91<50+a+b+c+d+e/2

50.2<a+b+c+d+e/2 (2f)

By combining the formula (2e) and the formula (2f), the formula (2) is obtained. All of “a” “b” “c” “d” and “e” are more than 0.

50.2<a+b+c+d+e/2<52.7 (2)

By setting [a+b+c+d+e/2] representing the amount of Fe₂O₃ to more than 50.2 and less than 52.7, μ′ in a high frequency region can be reliably increased. [a+b+c+d+e/2] may be 50.4 or more. In addition, [a+b+c+d+e/2] may be 52.0 or less.

In the sintered body of the present embodiment, the amount of each of the [Fe₂O₃+Mn₂O₃+(3/2) ZrO₂] and Fe₂O₃ is set within a predetermined range, and then the contained mole parts “f”, “g”, and “h” of Al, Co, and Cr are strictly controlled within the following range.

0.0012≤f≤0.010 (3)

0.0005≤g≤0.0015 (4)

0.0005≤h≤0.004 (5)

By limiting the content of each of Al, Co, and Cr to the above predetermined ranges, Cu segregation can be suppressed as shown in the FIGURE of Examples described later, and higher μ′ in a high frequency region can be realized. The reason why the Cu segregation can be suppressed by strictly controlling the content of each of Al, Co, and Cr is considered as follows. Since Al, Co, and Cr are elements that are difficult to be solid-solved in spinel, it is presumed that the excess thereof is bonded to Cu as a liquid phase component to form precipitates as impurities, thereby causing Cu segregation. By suppressing the amount of each of “f”, “g”, and “h” of Al, Co, and Cr to 0.010 or less, 0.0015 or less, and 0.004 or less, respectively, Cu segregation is suppressed, and high μ′ in a high frequency region can be realized. Al (f) is preferably 0.005 or less, and more preferably 0.003 or less. Co (g) is preferably 0.0010 or less, and more preferably 0.0008 or less. Cr (h) is preferably 0.0030 or less, and more preferably 0.0015 or less. Since Cu segregation is likely to be formed in the range of [Fe₂O₃+Mn₂O₃+(3/2) ZrO₂] of the sintered body of the present invention, that is, in the case of a relatively high value of [Fe₂O₃+Mn₂O₃+(3/2) ZrO₂], it is particularly important to strictly control the content of each of Al, Co and Cr. On the other hand, when the content of each of Al, Co, and Cr in the sintered body is too small, a liquid phase component is hardly formed and the sinterability is deteriorated, so that it is presumed that μ′ in a high frequency region is lowered. Therefore, Al (f) is 0.0012 or more, and each of Co (g) and Cr (h) is 0.0005 or more. Al (f) is preferably 0.0015 or more, and more preferably 0.0020 or more. Co (g) is preferably 0.0006 or more, and more preferably 0.0007 or more. Cr (h) is preferably 0.0007 or more, and more preferably 0.0010 or more.

According to the present invention, the amount of each of [Fe₂O₃+Mn₂O₃+(3/2) ZrO₂] and Fe₂O₃ is set within a predetermined range, and the amount of Al, the amount of Co, and the amount of Cr are strictly controlled within a very small range, which has not been made in the prior art. Thereby, μ′ in a high frequency region can be more reliably improved.

The sintered body of the present embodiment contains Fe, Ni, Cu, Zn, Zr, Mn, Al, Co, and Cr, for example, as a complex oxide. The sintered body of the present embodiment can be a complex oxide of Fe, Ni, Cu, Zn, Zr, Mn, Al, Co, and Cr. The sintered body of the present embodiment may contain inevitable impurities as described above.

In the sintered body of the present embodiment, it is preferable that the “d” indicating the amount of Zr further satisfies the following formula (6), and the “e” indicating the amount of Mn satisfies the following formula (7).

0.10≤d≤0.50 (6)

0.055≤e≤0.25 (7)

The amount of Mn (e) is set within a predetermined range, and then ZrO₂ is contained such that the amount of Zr (d) falls within the above range, and thereby μ′ in a high frequency range can be further improved. This is presumably because the amount of Mn (e) is set within a predetermined range and Zr is added in a predetermined amount, thereby decreasing magnetic anisotropy and further improving μ′ in a high frequency region. From the viewpoint of further decreasing magnetic anisotropy and further improving μ′ in a high frequency region, the amount of Mn (e) is more preferably 0.064 or more and more preferably 0.22 or less. The amount of Zr (d) is more preferably 0.20 or more and more preferably 0.40 or less.

In the sintered body of the present embodiment, although not particularly limited, the ratio of (Ni+Cu)/Zn in terms of molar concentration ratio corresponds to the Curie temperature, and the Curie temperature is also increased by increasing the ratio. The possible range of (Ni+Cu)/Zn includes 0.5 to 1.1.

The present embodiment is characterized by the component composition of the sintered body, and the production method thereof is not limited. As the production method, a conventionally performed method may be adopted. Examples thereof include blending a plurality of oxides as blended raw materials, adding pure water, and blending additives such as a dispersant and a stabilizer. Instead of the oxide, or together with the oxide, a compound that forms an oxide by firing, such as a halide or an organometallic compound, may be blended.

The blended raw materials are mixed to obtain a raw material mixture. For example, as in Examples described later, mixing and pulverization using a ball mill is performed. Subsequently, calcination of the raw material mixture is performed at, for example, 650° C. or more and 850° C. or less. After the calcination, pulverization is performed to obtain a pulverized material. At this time, a binder, a sintering aid, and the like for molding and sintering are added and mixed and pulverized. The mixed pulverized product is granulated to obtain a granulated product, and then the granulated product is molded to obtain a molded body. Thereafter, main firing of the molded body is performed, for example, in a range of 900° C. or more and 1200° C. or less to obtain a sintered body.

### EXAMPLES

Hereinafter, the present invention will be described more specifically with reference to Examples. The present invention is not limited by the following Examples, and can be implemented with appropriate modifications within the scope that can be consistent with the above-described and later-described gist, and any of them is included in the technical scope of the present invention.

### Preparation of Ferrite Sintered Body

### Example 1

First, Fe₂O₃, CuO, NiO, ZnO, Mn₂O₃, ZrO₂, Al₂O₃, Co₃O₄, and Cr₂O₃ were weighed as blended raw materials so as to have the formulation of Examples 1-1 to 1-9 in Table 1 as formulation after firing. In the Examples, in order to strictly control the content of a trace amount of Al, Co, and Cr, oxide materials having high purity were prepared. The purity of each of the oxide materials was Fe₂O₃: 99.9%, ZnO: 99.7%, NiO: 99.3%, and CuO: 99.96%. Since the amount of other oxide materials used is very small, it is considered that the influence of impurities mixed therein is also extremely small.

The weighed blended raw materials were put in a ball mill together with pure water, a dispersant, and PSZ (partially stabilized zirconia) balls, and mixed and pulverized for 6 hours in wet process. The resultant was evaporated to dryness and then calcined at 750° C. for 2 hours to prepare a calcined product (calcined powder).

The obtained calcined powder was put in a ball mill together with pure water, a binder (acrylic binder), an antifoaming agent, and PSZ balls, and mixed and pulverized in wet process. The mixed and pulverized slurry was evaporated to dryness, and then granulated to obtain a granular powder. The prepared granular powder was filled in a mold having an inner diameter of 12 mm and an outer diameter of 20 mm, and pressure-molded to obtain a toroidal-shaped molded body. Next, the molded body was fired by being held in a firing furnace at the firing temperature described in Table 1 for 1 hour in the air atmosphere to obtain a toroidal-shaped ferrite sintered body.

### Example 2

A sintered body was prepared in the same manner as in Example 1 except that Fe₂O₃, CuO, NiO, ZnO, Mn₂O₃, ZrO₂, Al₂O₃, Co₃O₄, and Cr₂O₃ were weighed as blended raw materials so as to have the formulation of Examples 2-1 to 2-7 in Table 1 as formulation after firing.

### Example 3

A sintered body was prepared in the same manner as in Example 1 except that Fe₂O₃, CuO, NiO, ZnO, Mn₂O₃, ZrO₂, Al₂O₃, Co₃O₄, and Cr₂O₃ were weighed as blended raw materials so as to have the formulation of Examples 3-1 to 3-5 in Table 1 as formulation after firing.

### COMPARATIVE EXAMPLE

A sintered body was prepared in the same manner as in Example 1 except that Fe₂O₃, CuO, NiO, ZnO, Mn₂O₃, ZrO₂, Al₂O₃, Co₃O₄, and Cr₂O₃ were weighed as blended raw materials so as to have the formulation of Comparative Examples 1-1 to 1-12 in Table 1 as formulation after firing.

[Evaluation of Ferrite Sintered Body]

The μ′ at 100 kHz and the Curie temperature were determined as follows using the ferrite sintered bodies obtained in [Example 1], [Example 2], [Example 3], and [Comparative Example]. Further, microscopic observation of the ferrite sintered body was performed to confirm the presence or absence of Cu segregation, and perform component composition analysis.

(Measurement of μ′ at 100 kHz and Curie Temperature)

For the obtained sintered body, μ′ at 100 kHz was measured using an impedance analyzer (Model 4294A; manufactured by KEYSIGHT TECHNOLOGIES). The obtained μ′ at 100 kHz is shown in Table 1.

In addition, Cu wire was wound around the sintered body 20 times, and the temperature characteristic of μ′ at 100 kHz was measured using an LCR meter (Model E4980; manufactured by Agilent) to calculate the Curie temperature. The Curie temperature was calculated as follows. That is, in the graph with the horizontal axis representing temperature and the vertical axis representing μ′ at 100 kHz, when μ′ at room temperature is 100%, the Curie temperature was determined as the temperature at which the straight line passing through the points of μ′ being 80% and 20% indicates μ′=1. At the time of measuring the temperature, the sintered body was placed in a thermostatic bath (Type STH-120; manufactured by ESPEC), and the temperature was changed from room temperature to 200° C. The calculated Curie temperature (Tc) is shown in Table 1.

(Microscopic Observation)

For each of the toroidal-shaped ferrite sintered bodies of Example 1-1 and Comparative Example 1-3, the sintered bodies were cut and embedded in a resin using an epoxy resin and a curing agent so that a section substantially perpendicular to the circumferential direction and substantially horizontal to the axial direction and the radial direction can be observed. The cut surface of the sintered body embedded in the resin was mirror-polished by an automatic polishing machine. The mirror-polished surface was subjected to SEM-WDX analysis using a scanning electron microscope (JXA-8530F; manufactured by JEOL Ltd.) to obtain a reflected electron image and determine the distribution state of Cu. The results are shown in the FIGURE. In the FIGURE, it can be seen that Cu segregation shown as white spots is observed more in Comparative Example than in Examples. It is presumed that the Cu segregation in Comparative Example occurred because the content of each of Al, Co, and Cr was out of the specified range as described above.

(Component Composition Analysis and Calculation of a Value and β Value as Index)

The obtained sintered body was pulverized in a mortar, and then the content of each of Fe, Zn, Ni, Cu, Zr, Mn, Al, Co, and Cr was measured using ICP-AES/MS. The results of calculating the contained mole part of these elements with respect to 100 mole part of Fe are shown in Table 1. In addition, the α value (=100−a−b−c+2 d+(1/2)e) and the β value (=a+b+c+d+e/2) were calculated when Zn, Ni, Cu, Zr, and Mn have mole parts: a, b, c, d, and e, respectively, based on Fe being 100 mol. In addition, (Ni+Cu)/Zn, having a deep relationship with the Curie temperature, was also calculated. These results are shown in Table 1.

TABLE 1

| | Firing | Mole part of each element based on Fe being 100 mol | | | | | | | |
|---|---|---|---|---|---|---|---|---|---|
| | temperature | Zn | Ni | Cu | Zr | Mn | AI | Co | Cr |
| No. | (° C.) | (a) | (b) | (c) | (d) | (e) | (f) | (g) | (h) |
| Example 1-1 | 1050 | 31.1 | 12.7 | 7.08 | 0.091 | 0.41 | 0.0024 | 0.0008 | 0.0011 |
| Comparative | 1050 | 31.1 | 12.7 | 7.08 | 0.091 | 0.41 | 0.012 | 0.0008 | 0.0011 |
| Example 1-1 | | | | | | | | | |
| Comparative | 1050 | 31.1 | 12.7 | 7.08 | 0.091 | 0.41 | 0.0005 | 0.0008 | 0.0011 |
| Example 1-2 | | | | | | | | | |
| Comparative | 1050 | 31.1 | 12.7 | 7.08 | 0.045 | 0.39 | 0.017 | 0.0019 | 0.0048 |
| Example 1-3 | | | | | | | | | |
| Comparative | 1050 | 31.1 | 12.7 | 7.08 | 0.091 | 0.41 | 0.0024 | 0.0003 | 0.0011 |
| Example 1-4 | | | | | | | | | |
| Comparative | 1050 | 31.1 | 12.7 | 7.08 | 0.091 | 0.41 | 0.0024 | 0.0008 | 0.0003 |
| Example 1-5 | | | | | | | | | |
| Example 1-2 | 1050 | 31.0 | 12.6 | 7.06 | 0.045 | 0.083 | 0.0024 | 0.0008 | 0.0011 |
| Example 1-3 | 1050 | 30.9 | 12.6 | 7.03 | 0.045 | 0.083 | 0.0024 | 0.0008 | 0.0011 |
| Example 1-4 | 1050 | 30.8 | 12.5 | 7.00 | 0.045 | 0.083 | 0.0024 | 0.0008 | 0.0011 |
| Comparative | 1050 | 30.6 | 12.5 | 6.97 | 0.045 | 0.083 | 0.0023 | 0.0008 | 0.0011 |
| Example 1-6 | | | | | | | | | |
| Example 1-5 | 1050 | 31.0 | 12.6 | 7.05 | 0.045 | 0.064 | 0.0024 | 0.0008 | 0.0011 |
| Example 2-1 | 1050 | 31.1 | 12.7 | 7.07 | 0.14 | 0.064 | 0.0024 | 0.0008 | 0.0011 |
| Example 2-2 | 1050 | 31.2 | 12.7 | 7.10 | 0.24 | 0.064 | 0.0024 | 0.0008 | 0.0011 |
| Example 2-3 | 1050 | 31.3 | 12.8 | 7.13 | 0.34 | 0.064 | 0.0024 | 0.0008 | 0.0011 |
| Example 2-4 | 1050 | 31.5 | 12.8 | 7.16 | 0.44 | 0.064 | 0.0024 | 0.0008 | 0.0011 |
| Comparative | 1050 | 31.4 | 12.8 | 7.15 | 0.14 | 0.083 | 0.0024 | 0.0008 | 0.0011 |
| Example 1-7 | | | | | | | | | |
| Comparative | 1050 | 31.7 | 12.9 | 7.20 | 0.34 | 0.083 | 0.0024 | 0.0008 | 0.0011 |
| Example 1-8 | | | | | | | | | |
| Comparative | 1050 | 31.8 | 12.9 | 7.23 | 0.44 | 0.083 | 0.0024 | 0.0008 | 0.0011 |
| Example 1-9 | | | | | | | | | |
| Comparative | 1050 | 31.9 | 13.0 | 7.26 | 0.54 | 0.083 | 0.0024 | 0.0008 | 0.0011 |
| Example 1-10 | | | | | | | | | |

| No. | (Ni + Cu)/Zn | α value | β value | μ′ | Tc (° C.) |
|---|---|---|---|---|---|
| Example 1-1 | 0.63 | 49.5 | 51.2 | 1700 | 140 |
| Comparative | 0.63 | 49.5 | 51.2 | 1560 | 141 |
| Example 1-1 | | | | | |
| Comparative | 0.63 | 49.5 | 51.2 | 1440 | 140 |
| Example 1-2 | | | | | |
| Comparative | 0.63 | 49.4 | 51.1 | 1590 | 140 |
| Example 1-3 | | | | | |
| Comparative | 0.63 | 49.5 | 51.2 | 1530 | 139 |
| Example 1-4 | | | | | |
| Comparative | 0.63 | 49.5 | 51.2 | 1530 | 140 |
| Example 1-5 | | | | | |
| Example 1-2 | 0.63 | 49.4 | 50.8 | 1660 | 141 |
| Example 1-3 | 0.63 | 49.6 | 50.6 | 1740 | 141 |
| Example 1-4 | 0.63 | 49.8 | 50.4 | 1900 | 141 |
| Comparative | 0.63 | 50.0 | 50.2 | 1350 | 150 |
| Example 1-6 | | | | | |
| Example 1-5 | 0.63 | 49.5 | 50.7 | 1610 | 140 |
| Example 2-1 | 0.63 | 49.5 | 51.0 | 1750 | 140 |
| Example 2-2 | 0.63 | 49.5 | 51.3 | 1760 | 140 |
| Example 2-3 | 0.63 | 49.5 | 51.6 | 1920 | 140 |
| Example 2-4 | 0.63 | 49.5 | 51.9 | 1970 | 139 |
| Comparative | 0.63 | 49.0 | 51.5 | 1280 | 131 |
| Example 1-7 | | | | | |
| Comparative | 0.63 | 49.0 | 52.1 | 1330 | 127 |
| Example 1-8 | | | | | |
| Comparative | 0.63 | 49.0 | 52.4 | 1300 | 127 |
| Example 1-9 | | | | | |
| Comparative | 0.63 | 49.0 | 52.7 | 1270 | 126 |
| Example 1-10 | | | | | |

TABLE 2

| | Firing | Mole part of each element based on Fe being 100 mol | | | | | | | |
|---|---|---|---|---|---|---|---|---|---|
| | temperature | Zn | Ni | Cu | Zr | Mn | AI | Co | Cr |
| No. | (° C.) | (a) | (b) | (c) | (d) | (e) | (f) | (g) | (h) |
| Example 1-6 | 1050 | 31.2 | 12.7 | 7.09 | 0.14 | 0.31 | 0.0024 | 0.0008 | 0.0011 |
| Example 1-7 | 1050 | 31.3 | 12.7 | 7.12 | 0.24 | 0.31 | 0.0024 | 0.0008 | 0.0011 |
| Example 1-8 | 1050 | 31.4 | 12.8 | 7.15 | 0.34 | 0.31 | 0.0024 | 0.0008 | 0.0011 |
| Example 1-9 | 1050 | 31.1 | 12.7 | 7.07 | 0.14 | 0.042 | 0.0024 | 0.0008 | 0.0011 |
| Example 2-5 | 1050 | 31.1 | 12.7 | 7.08 | 0.14 | 0.074 | 0.0024 | 0.0008 | 0.0011 |
| Example 2-6 | 1050 | 31.1 | 12.7 | 7.08 | 0.24 | 0.074 | 0.0024 | 0.0008 | 0.0011 |
| Example 2-7 | 1050 | 31.1 | 12.7 | 7.08 | 0.34 | 0.074 | 0.0024 | 0.0008 | 0.0011 |
| Comparative | 1050 | 31.1 | 12.7 | 7.08 | 0.44 | 0.074 | 0.0024 | 0.0008 | 0.0011 |
| Example 1-11 | | | | | | | | | |
| Comparative | 1050 | 31.1 | 12.7 | 7.08 | 0.54 | 0.075 | 0.0024 | 0.0008 | 0.0011 |
| Example 1-12 | | | | | | | | | |
| Example 3-1 | 1100 | 30.0 | 17.1 | 4.05 | 0.34 | 0.22 | 0.0024 | 0.0008 | 0.0011 |
| Example 3-2 | 1100 | 31.3 | 16.1 | 4.06 | 0.44 | 0.22 | 0.0024 | 0.0008 | 0.0011 |
| Example 3-3 | 1100 | 32.0 | 15.4 | 4.06 | 0.44 | 0.22 | 0.0024 | 0.0008 | 0.0011 |
| Example 3-4 | 1100 | 32.4 | 14.9 | 4.06 | 0.44 | 0.22 | 0.0024 | 0.0008 | 0.0011 |
| Example 3-5 | 1100 | 33.6 | 13.7 | 4.06 | 0.44 | 0.22 | 0.0024 | 0.0008 | 0.0011 |

| No. | (Ni + Cu)/Zn | α value | β value | μ′ | Tc (° C.) |
|---|---|---|---|---|---|
| Example 1-6 | 0.63 | 49.5 | 51.2 | 1810 | 140 |
| Example 1-7 | 0.63 | 49.5 | 51.5 | 1820 | 140 |
| Example 1-8 | 0.63 | 49.5 | 51.8 | 1830 | 140 |
| Example 1-9 | 0.63 | 49.5 | 51.0 | 1570 | 140 |
| Example 2-5 | 0.63 | 49.5 | 51.0 | 1700 | 140 |
| Example 2-6 | 0.63 | 49.6 | 51.1 | 1940 | 140 |
| Example 2-7 | 0.63 | 49.8 | 51.2 | 2110 | 140 |
| Comparative | 0.63 | 50.0 | 51.3 | 1420 | 140 |
| Example 1-11 | | | | | |
| Comparative | 0.63 | 50.2 | 51.4 | 1130 | 140 |
| Example 1-12 | | | | | |
| Example 3-1 | 0.71 | 49.6 | 51.6 | 1140 | 181 |
| Example 3-2 | 0.64 | 49.6 | 51.9 | 1580 | 160 |
| Example 3-3 | 0.61 | 49.6 | 51.9 | 1900 | 141 |
| Example 3-4 | 0.58 | 49.6 | 51.9 | 2080 | 126 |
| Example 3-5 | 0.53 | 49.6 | 51.9 | 2620 | 103 |

Examples 1-1 to 1-9 of [Example 1], Examples 2-1 to 2-7 of [Example 2], and Comparative Examples 1-1 to 1-12 are examples in which the ratio of (Ni+Cu)/Zn was controlled so that the Curie temperature was approximately 140. Based on these examples, the influence of the component composition on μ′ at 100 kHz in this Curie temperature range was confirmed.

Comparison of Example 1-1 with Comparative Example 1-1 and Comparative Example 1-2 shows that when the amount of Al (f) deviates from the upper limit value or the lower limit value, μ′ in a high frequency region decreases. Comparison of Example 1-1 with Comparative Example 1-3 to Comparative Example 1-5 shows that when the amount of Co (g) and the amount of Cr (h) deviate from the upper limit value or the lower limit value, μ′ in a high frequency region decreases. From these comparisons, it can be seen that the μ′ in a high frequency range can be reliably improved by strictly controlling the content of each of Al, Co and Cr to a very small appropriate range.

Examples 1-2 to 1-4 are examples in which the α value is changed. From the comparison between Examples 1-2 to 1-4 and Comparative Example 1-6, it is found that when the α value deviates from the upper limit value and the β value deviates from the lower limit value, μ′ in a high frequency region decreases.

Examples 1-5 and 2-1 to 2-4 are examples in which the amount of Zr (d) was changed. In addition, Comparative Example 1-7 to Comparative Example 1-10 are also examples in which the amount of Zr (d) is changed, and the α value is out of the range of the present invention. From the comparison between Examples 1-5 and 2-1 to 2-4 and Comparative Examples 1-7 to 1-10, it was found that the increase of the amount of Zr (d) increases μ′ in a high frequency region, but the increase of μ′ in a high frequency region is saturated when the amount of Zr is excessively increased. In addition, when the amount of Zr (d) was increased, in a case where the α value was out of the lower limit value, μ′ in a high frequency region decreased. In particular, from the comparison between Comparative Example 1-7 to Comparative Example 1-9 and Comparative Example 1-10, when both the amount of Zr (d) and the upper limit value of the β value deviated, μ′ in a high frequency region considerably decreased.

Comparison between Example 2-1 and Example 1-9 shows that when the amount of Mn is within a preferable range, μ′ is further increased in a high frequency region.

Examples 1-6 to 1-8 are examples in which the amount of Mn (e) is relatively large. When Mn exceeds the preferred range, the effect of higher μ′ in a high frequency region by adding Zr is weakened. Comparing Examples 1-5 and 2-1 to 2-4 with Examples 1-6 to 1-8, when the amount of Zr is lower than 0.34, μ′ in a high frequency region is higher in examples in which the amount of Mn is high, but when the amount of Zr is 0.34, μ′ in a high frequency region is higher in examples in which the amount of Mn is small.

Examples 2-5 to 2-7 are examples in which the α value and the amount of Zr (d) were changed. Comparing Examples 2-5 to 2-7 with Comparative Example 1-11, it is found that when the α value and Zr increase, μ′ in a high frequency region is improved, but when the α value exceeds the upper limit value, μ′ in a high frequency region decreases. Comparing Comparative Example 1-11 with Comparative Example 1-12, in each of which the α value is out of the range, the amount of Zr (d) deviates from the upper limit value together with the α value, thereby further decreasing μ′ in a high frequency region.

From the above examples, by setting the α value and the β value, that is, the amount of [Fe₂O₃+Mn₂O₃+(3/2) ZrO₂] and Fe₂O₃ within the specified ranges, the decrease of μ′ in a high frequency region due to relaxation loss can be suppressed. Further, by setting the amount of Al, the amount of Co, and the amount of Cr within the predetermined ranges, Cu segregation can be suppressed. As a result, high μ′ of 1600 or more at around Tc=140° C. was achieved in a high frequency region.

Further, as shown in [Example 2], by further setting the amount of Zr and the amount of Mn within predetermined ranges, magnetic anisotropy was reduced, and higher μ′ of 1700 or more at around Tc=140° C. was achieved in a high frequency region.

Furthermore, Examples 3-1 to 3-5 of [Example 3] are examples in which Tc was changed by changing (Ni+Cu)/Zn. Although Tc and μ′ are in a trade-off relationship, in these examples, high μ′ in a high frequency region was obtained at each Tc.

The sintered body of the present invention can be used as a sintered magnetic component in various electromagnetic machines/devices, for example, an inductor, a transformer, a coil, and the like.

1. A sintered body comprising:
a spinel ferrite oxide having a main constituent of metal elements of Fe, Ni, Cu, and Zn; and
Zr, Mn, Al, Co, and Cr,
wherein, when Zn, Ni, Cu, Zr, Mn, Al, Co, and Cr have a contained mole part: “a”, “b”, “c”, “d”, “e”, “f”, “g”, and “h”, respectively, and based on Fe being 100 mole parts:
49.0<100−a−b−c+2d+(1/2)e<50.0,
50.2<a+b+c+d+e/2<52.7,
0.0012≤f≤0.010,
0.0005≤g≤0.0015, and
0.0005≤h≤0.004.

2. The sintered body according to claim 1, wherein, based on Fe being 100 mole parts:
23.9≤a≤34.6,
6.7≤b≤27.0, and
0.1≤c≤10.2.

3. The sintered body according to claim 1, wherein
0.10≤d≤0.50, and
0.055≤e≤0.25.

4. The sintered body according to claim 1, wherein
0.20≤d≤0.40, and
0.064≤e≤0.22.

5. The sintered body according to claim 1, wherein a ratio of the spinel ferrite oxide in the sintered body is 90 mass % or more.

6. The sintered body according to claim 1, wherein:
0.0015≤f≤0.005,
0.0006≤g≤0.0010, and
0.0007≤h≤0.0030.

7. The sintered body according to claim 1, wherein:
0.0020≤f≤0.003,
0.0007<g≤0.0008, and
0.0010≤h≤0.0015.

8. The sintered body according to claim 1, wherein the sintered body is a complex oxide of Fe, Ni, Cu, Zn, Zr, Mn, Al, Co, and Cr.

9. The sintered body according to claim 1, wherein a ratio of (Ni+Cu)/Zn is 0.5 to 1.1.
